(19) United States
(12) Patent Application Publication
(10) Pub. No.: US 2021/0334711 A1
(43) Pub. Date: Oct. 28, 2021

(54) SYSTEM AND METHODS FOR CONNECTING CONTENT PROMOTERS AND ARTISTS FOR CONTENT PROMOTION TRANSACTIONS

(71) Applicant: BRKR.IO, Inc., Tallahassee, FL (US)

(72) Inventor: Ameer Brown, Tallahassee, FL (US)

(21) Appl. No.: 17/124,192

(22) Filed: Dec. 16, 2020

Related U.S. Application Data
(60) Provisional application No. 63/014,557, filed on Apr. 23, 2020.

(51) Int. Cl. G06Q 10/02; G06Q 50/00; G06Q 30/04

(52) U.S. Cl. CPC G06Q 10/02; G06Q 30/04; G06Q 50/01

(57) ABSTRACT

A system and methods for connecting content promoters and artists to facilitate integration of an artist's content into a promoter's performance at an event. The system allows a promoter to publish available slots in an event that might be filled with an artist's content. The system provides a user interface that allows promoters to specify parameters that characterize available slots at the event. The parameters may provide details about the event, details about the slots for which the promoter will accept requests, the characteristics of the content the promoter would prefer to play in an available slot, and prices that the promoter charges for content to be played during the slot. Once the promoter provides the system the details of the available slots, the system allows the promoter to publish the event/slots and make the published events/slots available for review by artists.

### CROSS-REFERENCE TO RELATED APPLICATION(S)

This application claims the benefit of the Applicant's U.S. Provisional Application No. 63/014,557, entitled “SYSTEM AND METHODS FOR CONNECTING DJS AND ARTISTS FOR SETLIST SLOT TRANSACTIONS,” filed Apr. 23, 2020, which is incorporated herein by reference in its entirety.

### BACKGROUND

Although a DJ's set may last only a few hours, DJs often spend many more hours before a show searching for new and upcoming music, identifying what songs/tracks can be played next to each other based on common musical characteristics, figuring out transitions between songs/tracks, and planning their setlist. Similarly, influencers who post via social media services or stream using online streaming platforms often seek songs/tracks to accompany their performances. While modern technology has made it easier to create and share music and other content with the world, the boom in content creation has made it harder for DJs and other content promoters to sift through all of the newest content while planning their performances. At the same time, the boom in music production and sharing has altered the way musical artists seek to gain exposure. Artists may now share their music through numerous platforms hoping to boost their publicity and be heard by more people. Because of the increase in sources of music and the many different channels for music distribution, many artists find it difficult to promote their music to DJs or other promoters in a manner that ensures that their tracks make their way into a setlist at popular clubs and events or into social media or other streaming channels. Accordingly, it would be desirable to provide a system that connects content promoters and artists and facilitates integration of an artist's content into a content promoter's performance.

### BRIEF DESCRIPTION OF THE DRAWINGS

FIG. 1 is a block diagram of a representative system in which aspects of the described technology may operate.

FIG. 2 is a flow diagram illustrating a process for managing transactions regarding slots in a content promoter's event between content promoters and artists.

FIG. 3 is a display diagram of an example user interface sign-up page for the creation of a profile in the system.

FIG. 4 is a flow diagram of a process for receiving set parameters surrounding available slots in a promoter's event.

FIG. 5 is a display diagram of a user interface that allows DJs to enter the set parameters in accordance with the process of FIG. 4.

FIG. 6 is a display diagram of an example user interface for searching and reviewing available slots in a DJ's setlist.

FIG. 7 is a flow diagram for a process for creating a submission requesting a promoter to play an artist's content during an available slot.

FIG. 8 is a display diagram of an example user interface that allows an artist to submit a track to a DJ for consideration.

FIG. 9 is a flow diagram of a process that allows a promoter to review and select content.

FIG. 10 is a display diagram of a user interface that the system generates for the DJ to review submissions from artists.

FIG. 11 is an illustration of additional example user interfaces that the DJs and artists use to interact with the system.

### DETAILED DESCRIPTION

A method and system are described for connecting content promoters (e.g., disc jockeys (DJs), social media influencers, streaming media influencers) and artists to facilitate integration of an artist's music or other digital content into a performance by the content promoter. For example, the system allows a content promoter to advertise available slots in an upcoming event that might be filled with an artist's track. As used herein, the term “event” can include any live or recorded, remote or in-person function at which a content promoter presents content. An event can include multiple performances by content promoters, such as multiple setlists performed by different DJs. An event can also be a single performance, such as a setlist or a post, video, or livestreamed performance by an online content promoter. To facilitate advertising of events and slots, the system provides a user interface that allows content promoters to specify parameters that characterize an upcoming event and a slot at that event that are available for tracks to be played. The parameters provide details about the event at which the content will be played (e.g., the location, time, number of attendees expected, number of followers, number of anticipated impressions), characteristics of the slots for which the content promoter will accept submissions (e.g., slot time, slot length, surrounding music), the musical characteristics of the tracks the content promoter would be willing to consider to play in the available slots (e.g., pitch, beat per minute (BPM) or pulse, tempo, rhythm, melody, harmony, texture, style, featured instruments, allocation of voices, keys, timbre or color, dynamics, expression, articulation, form and structure, etc.), and one or more prices that the content promoter charges for a track to be played during the available slots. In some embodiments, the price can be a flat rate charged to any artist whose track is selected for the slot. In some embodiments, the price can be a suggestion or baseline, allowing artists to bid alternative amounts in responding to the fill the available slot. Once the content promoter provides the system the details of the slot or slots that are available to the filled, the system allows the content promoter to publish information about the event and available slots and make the published event and slots available for review by artists.

Once published, available events and slots are discoverable by artists. Using the system, artists are able to search for slots with content promoters that they would like to have play their tracks and/or events where they would like to have their track played. The system provides a user interface that allows artists to search for events and/or slots based on event details, the specified musical characteristics, price-per-slot, and/or other details. When a desired slot (or slots) is identified, the artist can upload one or more tracks and submit a request for one of their uploaded tracks to be played in one of the marketed slots. In some embodiments, the system can further use track analysis to recommend slots to an artist, where the slots have specified musical characteristics similar to the musical characteristics identified in the artist's track.

As artists make submissions, the system collects and presents them to the publishing content promoter, who can then review the submissions, listen to the submitted tracks, and choose an artist/track to be played in the marketed slots. Once the content promoter accepts a track for a slot, the platform can bill the artist for the accepted submission at the specified price, close the available slot listing, and facilitate the content promoter playing the track (e.g., transfer a copy of the track and/or push reminders to the content promoter). In some embodiments, the platform may require the content promoter to submit proof the accepted track was played before the artist is billed, or before payment is transferred to the content promoter. In the latter embodiment, for example, funds can be held in escrow until the content promoter submits proof the track was played at the event. The review process allows the system to provide some protection for artists, who can be refunded if insufficient proof is submitted, as well as content promoters, by requiring artists to submit payment into escrow upfront.

By allowing a content promoter to specify details on required/preferred musical characteristics of tracks for a performance slot, and allowing artists to search based on those details, the system creates efficiencies in the transaction process. For example, the system helps streamline a content promoter's music-search process by facilitating a connection to music with specified characteristics. Notably, artists are the ones that help the content promoter find desired music by submitting tracks to content promoters meeting the specified characteristics. Further, the system allows artists to specifically connect with content promoters playing music or having a style that their tracks will fit well with, and/or target audiences based on musical characteristics and/or event details. For example, selecting between venues can be important because venues may be known for a certain type of music, may be known to be more popular at certain hours, and may be known to attract crowds for a particular genre. Selecting among content promoters can be important, for example, given variance in content promoter popularity, known content promoter genre types, and/or past behavior on the system. And by submitting music meeting the specified music characteristics, the artist is able to more readily avoid errors like submitting an upbeat track to a slow set or vice versa.

To help connect artists with content promoters, the system can, for example, allow artists to search or filter events based on parameters or characteristics. As illustrated in Table 1, the system stores information about event characteristics, such as event name, date and time, expected number of attendees or impressions, location (e.g., a physical or online location), and a number of slots available at the event. Other characteristics stored by the system can include, for example, names of content promoters associated with the event, information about other content that will be presented at the event (e.g., tracks immediately before and after the available slot), and so forth. Using an interface of the system, an artist can search or filter event listings based on any characteristics associated with the event. For example, an artist can select a filter to show events based on a number of attendees or impressions (e.g., a minimum number, maximum number, or a range). An artist can select multiple filters, for example, to display only weekend events featuring a specified content promoter. In response to the selected filters, the interface of the system displays only event listings having the characteristics specified by the artist. In some implementations, if the system identifies no listings having the characteristics specified by selected filters, the system can suggest a closest match or alternative filter selections that will display event listings having characteristics similar to those sought by the artist.

TABLE 1

| | | Attendees/ | | Slots |
|---|---|---|---|---|
| Event Name | Date & Time | Impressions | Location | Available |
| Fortnite | Oct. 31, 2021, | 150,000 | Twitch | 3 |
| Quarterfinals | 10:00 PM | | | |
| Downtown | Feb. 12, 2021, | 150 | Downtown | 1 |
| Club Friday | 11:30 PM | | Club | |
| Night | | | | |
| New Year's | Dec. 31, 2021, | 2,500 | City Center | 6 |
| Eve Party | 9:00 PM | | | |
| Tournament | Aug. 16, 2021, | 10,500 | Instagram | 6 |
| Live Stream | 2:30 PM | | | |

The system can thus retrieve and display event listings based on filtered event characteristics, such as according to the following operations:

If SelectedFilter=attendees(250-500), then retrieve events where attendees=(250-500).

If SelectedFilter=promoter(DJ1), then retrieve events where promoter=DJ1.

If SelectedFilter=SlotsAvailable, then retrieve events where available slots>=1.

If SelectedFilter=location(Twitch), then retrieve events where location=(Twitch) . . .

The system can also filter displayed listings based on filters for characteristics of available slots. As illustrated in Table 2 below, the system stores information about characteristics of content that a promoter is willing to present during an available slot, such as genre, length or duration, beats per minute, or “vibe” (e.g., mood or other subjective descriptions or characteristics). Other slot characteristics can include subgenre, slot price, information about content that will be presented before or after the slot (e.g., artists or tracks that will be presented), tempo, pitch (e.g., an average pitch), key, instrumentation, and so forth. Using an interface of the system, an artist can select filters for these and other slot characteristics, and the system can retrieve and display slot listings having the characteristics specified by the artist. In some implementations, if the system identifies no slot listings having the characteristics specified by selected filters, the system can suggest a closest match or alternative filter selections that will display slot listings having characteristics similar to those sought by the artist.

TABLE 2

| | | | |
|---|---|---|---|
| Genre | Length | BPM | Vibe |

| | | | | |
|---|---|---|---|---|
| Hip Hop | 4 | min. | 80-90 | Relaxed |
| Rock | 3.5 | min. | 145-155 | Fun |
| Jazz | 6 | min. | 120-130 | Upbeat |
| Pop | 3.5 | min. | 110-120 | Danceable |

Content promoters can be DJs, influencers, streamers, internet celebrities, podcasters, or any other person or character who gives performances at events that can incorporate an artist's digital content. Promoters may give performances, for example, online through various streaming or social media platforms (e.g., YouTube, Twitter, TikTok, Twitch, Facebook, Instagram, etc.). Furthermore, in addition to music tracks, content created by an artist and promoted via the system can be any digital media capable of being included in a performance by a content promoter, such as music, spoken word, animation, video, or graphic art. Accordingly, a slot offered by a content promoter via the system can comprise inclusion of an artist's digital content in any event, such as including the content in a video, podcast, photo, social media post, or other performance. For purposes of illustration, the system is described herein using examples relating to DJs and musical artists, in which DJs advertise available slots for performance of musical tracks in a setlist. However, the system is not limited by these example implementations. These and other embodiments will become apparent to a person skilled in the art based on the descriptions provided herein.

As will be described in additional detail herein, the system employs various computer systems and applications to facilitate transactions between promoters and artists. Aspects of the system may be implemented using cloud services to generate user interfaces, store tracks, and manage communications and payment. Aspects of the system may also be implemented in one or more stand-alone applications on mobile devices or personal computers. The stand-alone applications may interface with remote servers via wired or wireless communication networks.

Various embodiments of the invention will now be described. The following description provides specific details for a thorough understanding and an enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments of the invention.

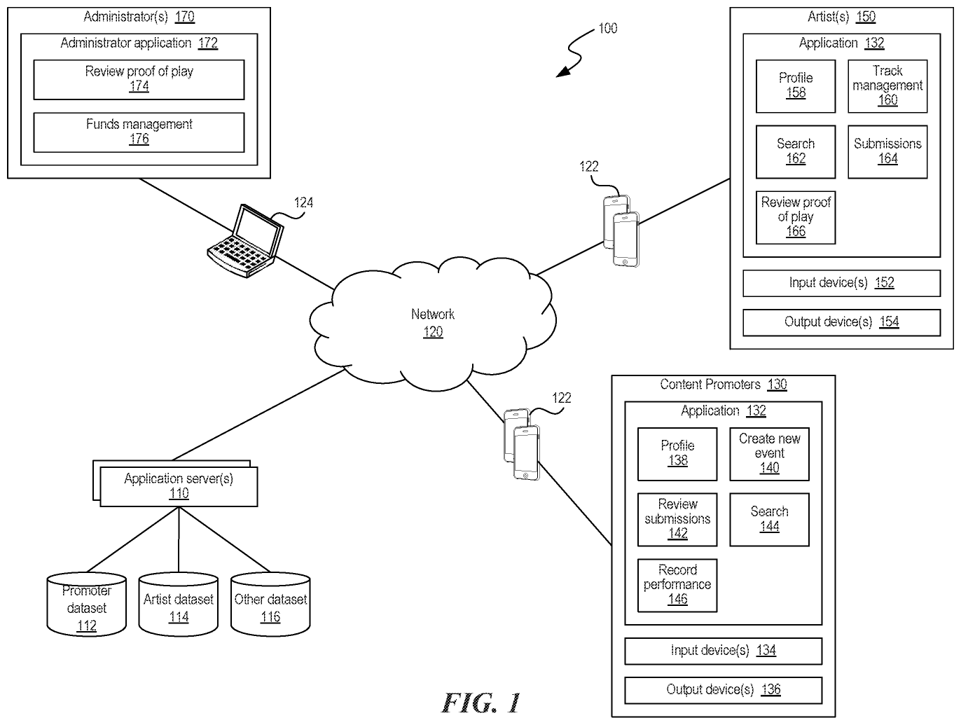

FIG. 1 is a block diagram of a representative system 100 in which aspects of the described technology may operate. The system 100 includes one or more application server(s) 110. In some embodiments, the application server(s) 110 are associated with a web site through which the system 100 may be accessed by content promoters, artists, administrators, and other users.

The application server(s) 110 are coupled to a promoter dataset 112, an artist dataset 114, and one or more other datasets 116. The promoter dataset 112 stores information related to promoter profiles, events, setlists or other available performances, available slots in setlists or performances, videos of setlists/slots/performances, promoter statistics and/or other multimedia and metadata associated with promoters in the system 100. As described herein, a promoter can be, for example, a DJ or other influencer. The artist dataset 114 stores audio recordings of artist tracks, other content associated with an artist (e.g., video, images, audio, or other media), information relating to artist profiles, requests for play, artist statistics, and/or other multimedia and metadata related to artists within the system 100. The one or more additional datasets 116 can store metadata, usage statistics, administrator profiles, and/or other information associated with the system. Note that although the promoter dataset 112, artist dataset 114, and other datasets 116 are depicted in FIG. 1 as separate datasets, a single dataset and/or other combinations of datasets may store the information necessary for the system in various embodiments. The datasets may be maintained in a relational or non-relational database, data tables, flat files, or other data storage structures. The information stored in the datasets, as well as the system's use of the information, is illustrated by the discussion of the system 100 below.

The application server(s) 110 are accessed by mobile devices 122, laptop or desktop computers 124, or other computing device (not shown) via a network 120, such as the Internet, a wide area network (WAN), a local area network (LAN), or any other combination of public or private, wired or wireless, networks. The term computer or computing device, as used herein, may include general purpose computer systems, televisions, set-top boxes, microprocessor-based or programmable consumer electronics, Internet appliances, multi-processor systems, network PCs, mini-computers, and the like. The term computer or computing device may also refer to a special purpose computer or data processor that is specifically programmed, configured, or constructed to perform one or more computer executable instructions. The technology described herein may therefore be operated on a mobile device, such as a smartphone, a portable email device, a portable gaming device, or a tablet or touch screen display device.

In the illustrated embodiment, a promoter may access the functionality of the system via an application 132 operating on a computing device. The application 132 operates on a computing device having input devices 134 (e.g., keyboard, touchscreen, camera) and output devices 136 (e.g., touchscreen, speaker)—which can be housed in a single device, such as a mobile device 122. The application 132 allows promoters to submit information on new events and available slots to the application servers 110. The application 132 allows a promoter to review submissions for marketed slots and play musical tracks or otherwise access artist content. In the illustrated system 100, the application 132 includes a number of modules to allow the promoter to interact with the system. The application 132 includes a profile module 138 that allows the promoter to create and/or edit their system profile; a create new event module 140 to allow the promoter to describe the details of an event at which content will be played or displayed, the available slots in the setlist or performance, details about the musical or other characteristics the promoter seeks to fill the available slots, etc.; a review submissions module 142 that allows the promoter to review submissions for marketed slots and accept or reject those submissions; a search module 144 that allows the promoter to search for other content, artists, upcoming events, and/or other promoters in the system 100; and a record performance module 146 that allows, in some embodiments, a promoter to record a video or other media of one or more slots in their performance and submit the recorded recordings as proof that the submitted content was indeed played at the desired place and time in the promoter's performance. The application 132 communicates with the application server(s) 110 via an API.

An artist seeking to submit content to a promoter may also access the functionality of the system via the application 132 operating on a computing device. The application 132 operates on a computing device having input devices 152 (e.g., keyboard, touchscreen) and output devices 154 (e.g., touchscreen, speaker)—which can be housed in a single device, such as a mobile device 122. The application 132 can be used to record or upload tracks or other content to the system 100 (for storage in the artist dataset 114), submit content responsive to available slots through the system 100, submit payment for any content accepted by promoters, communicate with the promoter, and/or any other inputs required from artists. After a track or other content has been submitted to a promoter, the application 132 can be used to receive and review proof of play (e.g., may be used to play recordings submitted by DJs or other promoters, or to watch or review performances to confirm that the digital content was appropriately displayed or played), receive and display messages, and/or any other communications sent to artists. To perform these functions, the application 132 includes several modules tailored for the artist to use. For example, the application 132 includes a profile module 158 that allows an artist to create and/or edit a profile maintained by the system; a content management module 160, which allows artists to upload, characterize, and maintain one or more tracks or other content created by the artist; a search module 162 that allows the artist to search for events/sets/performances using information such as event details, set or performance details, specified musical characteristics, and/or other information; a submissions module 164 that allows the artist to submit tracks or other content responsive to a promoter's advertised slot(s), including managing or deleting those submissions under certain circumstances, and; a review proof of play module 166 that, in some embodiments, allows the artist to review video and/or audio evidence that the content was actually played by the promoter at the agreed to event and slot.

Finally, a system administrator seeking to manage the system 100 may access the system via an administrator application 172 operating on a computing device. The administrator application 172 allows a system administrator to review various user behaviors and help police transactions. The administrator application 172 includes, for example, a review proof of play module 174 that allows administrators to review challenges to a proof of play. For example, if an artist rejects a promoter's proof of play, an administrator can review the challenge to check that the rejection is legitimate. In one embodiment, the administrator can end the transaction upon this determination. In another, the administrator may contact the promoter to seek further proof of play for review and/or may hear explanations from the promoter on the quality of proof. The administrator application 172 also includes a funds management module 176 that automatically releases funds to promoters after their performance of a track or other content and receipt of confirmation from the artist that the proof of play is acceptable. The funds can be held in escrow account(s) maintained by the system. That is, the system may collect funds from the artist when an artist's submission has been accepted by a promoter and hold those funds until the artist has approved of the proof of play. The use of escrow allows the funds to be held in a neutral account to better ensure payment will be made when a promoter's performance is completed.

While the application 132 and administrator application 172 are depicted as two applications in FIG. 1, it will be appreciated that the applications may be the same application with different interfaces that are presented to a user depending on the role of the user using the system. Additionally, while different modules are described as being responsible for certain functionality, the module functionality may be combined into less modules or divided into additional modules depending on the system architecture.

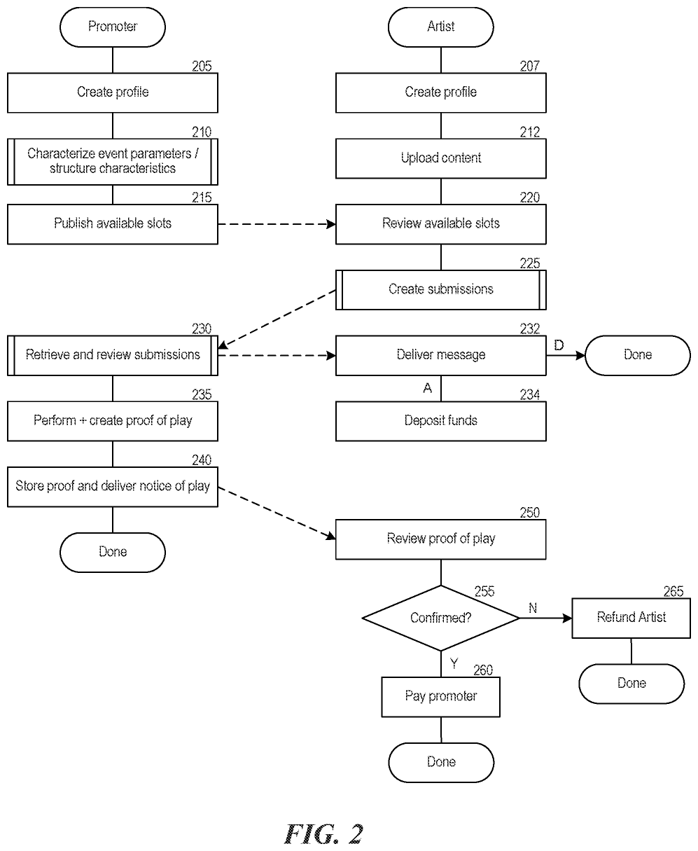

FIG. 2 is a flow diagram illustrating a process 200 the system executes to connect promoters and artists for transactions relating to slots in a promoter's event or performance at the event. The process 200 starts with promoters and artists accessing the system via the application 132. The first time they log on, the system prompts a promoter to create a profile at block 205, and the system prompts an artist to create a profile at block 207.

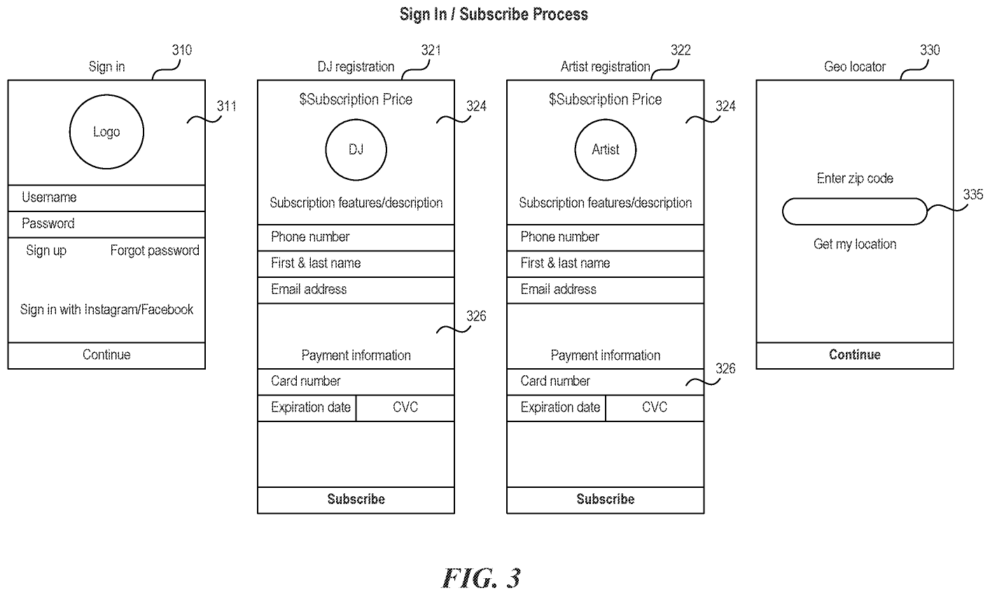

FIG. 3 is a display diagram of an example user interface sign-up page 310 for the creation of a profile. In the depicted example implementation of FIG. 3, the system is configured such that the promoter is a DJ and the artist is a musical artist. The sign-up page 310 includes a display area 311, and an input area 313. The display area 311 can display a logo, instructions for signing up, information about the system, and/or other graphics or information. The input area 313 allows the new user to enter basic information about the user, such as a username and password for the user account. In some embodiments, the input area 313 can include a feature allowing a user to shortcut through the sign-up page 310 and registration page 320 by connecting the user-account with their Instagram, Facebook, Google, and/or other pre-existing account.

After creating a username and password, the new user is allowed to register as either a DJ using a DJ registration interface 321 or register as an artist using an artist registration interface 322. Both the DJ registration interface and the artist registration interface include a display area 324 and an input area 321, and are similar in structure. In the display area 324, the DJ or artist is allowed to submit a picture, select an icon or other identifier, and otherwise provide a description of themselves to distinguish from other DJs or artists. In the input area 326, a DJ or artist submits contact information and financial information that is sufficient to allow payment to be made or received. For example, the input area may include text entry fields that allow the DJ or artist to enter contact information (e.g., name, phone number) and payment information (e.g., credit card information or provide an account to receive payments). The input area 326 may also allow a DJ to submit information about the DJ's past performances, social media links, and/or other information related to the DJ. For an artist, the input area 326 may also allow an artist to submit information related to the artist's history, social media links, and/or other information related to the artist. In some embodiments, after certain registration information has been received by the system, the system can display a geolocation interface 330, allowing the user to input geographic location information such as by entering a zip code in field 335. In some embodiments, the geolocation interface 330 may request to use GPS information from a personal electronic device, such as a smartphone. In some embodiments, the geolocation interface 330 can request the user enter an address to set a location associated with the user.

After registration is complete, the application can guide users through a variety of orientation screens. For example, the application can orient users on navigation or menu functions in the application. Further, the application can include a series of onboarding videos (not shown) that describe various capabilities and functions of the application.

Returning to FIG. 2, after the system has guided a promoter through creating a profile and oriented them on the platform at block 205, the process 200 continues to function block 210 where the system allows the promoter to create and characterize event parameters (e.g., to provide certain descriptive characteristics about an upcoming DJ set or other performance) and, in some circumstances, specify characteristics of preferred music or other content that is suitable for the event.

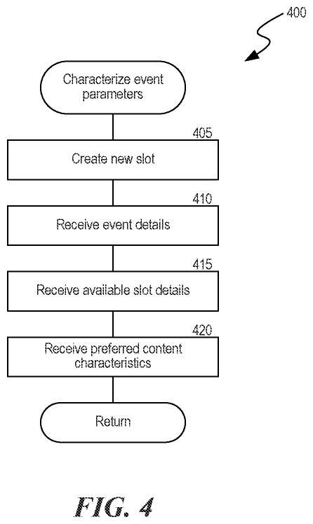

FIG. 4 is a flow chart of a process 400 executed in function block 210 for the system to receive event parameters surrounding available slots. At block 405, the system receives a request from the promoter to create a slot that is available in the promoter's event for which the promoter is willing to accept submissions from artists. At block 410, the system prompts the promoter for details about the event at which the content will be presented. Details of the event might be relevant to an artist as to whether they want their content played at the event. Details about the event can include, but are not limited to, one or more of the days of the event, the physical location of the event (e.g., address or venue) or virtual location of the event (e.g., social media service address, live stream address), the start and end times of the event, the name of the event, the theme of the event, and the expected number of attendees at the event. For events that are a social media post, live stream, podcast, or other online performance by a promoter, the event details can also include expected type and number of user interactions (e.g., views, clicks, streams, impressions), number of followers, cross promotion with other events, and so forth.

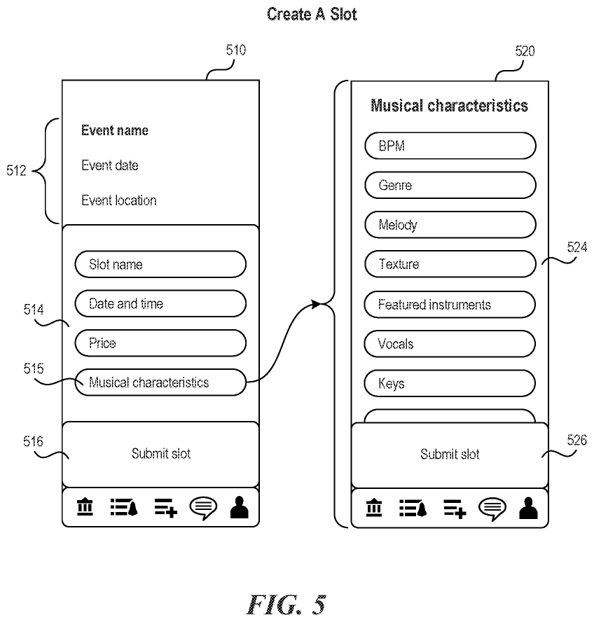

FIG. 5 is a display diagram of an example user interface 510 that allows a promoter (e.g., a DJ) to enter the event parameters in accordance with process 400. As illustrated in FIG. 5, in an example implementation where the promoter is a DJ, a region 512 of the interface 510 allows the DJ to enter the event details. The details may be entered as text, or certain entries might be selected via drop-down menus or other GUI elements.

Returning to FIG. 4, at block 415 the system prompts the promoter to specify an available slot at the event. A slot is “available” when the promoter is willing to allow content that is submitted by an artist to be played or presented during that slot. In the example of FIG. 5, as illustrated in display region 514, the system allows the DJ to characterize an available slot by specifying a name for the slot, a date and specific time for the available slot (e.g., if the event is a weekend music festival and the set is to be played from 8:00-10:00 PM on Saturday, an available slot may be at around 8:45 PM on Saturday, etc.), and a price that the DJ is willing to accept for playing the track during that slot.

At block 420, the system allows the promoter to specify the preferred characteristics of content that the promoter would be willing to play in the available slot. In the example of FIG. 5, display region 514 includes a “musical characteristics” button 515 that, when selected by the DJ, takes the DJ to user interface 520. Interface 520 includes a series of buttons that, when selected, allow the DJ to input desired musical characteristics such as beats per minute (BPM), genre, pitch, pulse, tempo, rhythm, melody, harmony, texture, style, featured instruments, inclusion or exclusion of vocals, keys, timbre or color, dynamics, expression, articulation, form and structure, and/or other musical characteristics of a track that the DJ considers relevant. It will be appreciated that the DJ may enter one or more of the music characteristics that are desired in a submitted track. In some embodiments, the system permits the DJ to enter a range or approximation for a musical characteristic (e.g. 120-140 BPM, around 90 BPM, approximately ternary form for structure, etc.). In some embodiments, the system permits the DJ to enter more than one entry for a preferred musical characteristic (e.g. track features a saxophone, electric guitar, and electronic bass; track is in the range of 80-100 BPM or 120-135 BPM). By allowing the DJ to enter approximations, ranges, or multiple options for musical preferences, the system can allow the DJ to better target specific genres and track characteristics, and/or consider potentially contrasting options for the slot (e.g. compare a relatively slow song break in the setlist vs. keeping a high tempo in the setlist). Once the DJ specifies the desired characteristics, they can submit the entered characteristics by selecting button 526 to return to interface 510.

Although not depicted in FIG. 5, the interface 510 may also allow the DJ to specify other details relevant to the music sought to be played in the marketed slot. For example, if a DJ prefers not to use music from certain artists, the DJ may be allowed to bar that artist from submitting tracks responsive to the available slots. When the event details and characteristics of the slot have been entered by the DJ, the DJ submits the slot to the system by selecting button 516.

In the example of FIG. 5, after having submitted a slot for a particular setlist, the system allows the DJ to specify other slots for the same setlist. For example, for a particular setlist that lasts from 11 pm until 2 am, the DJ may have three available slots at around 11:30 pm, around 12:15 am, and around 12:50 am. In such a case, the system allows the DJ to create three available slots and specify different preferred musical characteristics for each slot.

Although interfaces 510 and 520 are discussed as separate interfaces, they may be combined in a single interface to receive the various inputs discussed above. For example, they may be a single interface a DJ can scroll down through in order to input the requested information. In some embodiments, process 400 can occur through one or more other interfaces designed to prompt a DJ or other promoter for details about the event, set, performance, available slots, and musical or other content characteristics sought.

After receiving all event parameters, processing continues at block 215 of FIG. 2. At block 215, the system outputs/publishes the availability of a new slot or slots to the community of artists that use the system. That is, the system makes the new slot or slots available for searching, such that artists looking to submit content to the promoter are able to locate a slot and submit content that is responsive to the characterized slot. The system also stores all details about the available slot or slots in, for example, the promoter dataset 112.

After the system publishes available slots at block 215, artists are allowed to review those slots and identify content that might be responsive to those slots. At block 212, the system allows an artist to upload, link, or otherwise transfer content of the artist to the system. Uploaded content from the artist can be stored in, for example, the artist dataset 114. Alternatively, the system can receive content later in the process 200, such as only after an artist has identified an available slot and wants to upload content that is responsive to that slot.

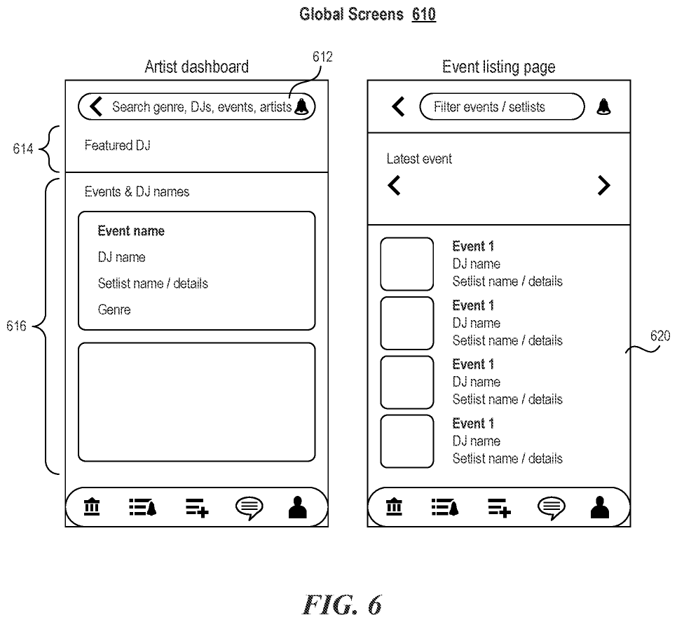

At block 220 the system allows an artist to search and review available slots. One embodiment of an interface for reviewing slots is illustrated in the user interface 610 of FIG. 6, in which the artist is a musical artist and the promoter is a DJ. In the illustrated embodiment, an artist can search available slots by entering search criteria into search field 612. For example, an artist can search for available slots based on event names, event locations, event dates, set names, slot times, various specified musical characteristics, DJ names, and/or various other information. It will be appreciated that the system can allow an artist to search for approximations, ranges, and/or using various Boolean search strings. Additionally, the interface 610 can include a featured display region 614 that can cycle among featured slots, DJs, events, event locations, and/or other tags. The search results and/or featured items are displayed by the system in results display region 616. If an artist selects an event in results region 616, the system displays to the artist an event listing page 620, which displays to the artist a list of all DJs that are playing at the event. If an artist selects a particular DJ that is playing at the event, the system displays to the artist a list of the available slots in that DJ's setlist (not shown). In that manner, the system allows an artist to quickly review available events, setlists at that event, and available slots within each setlist.

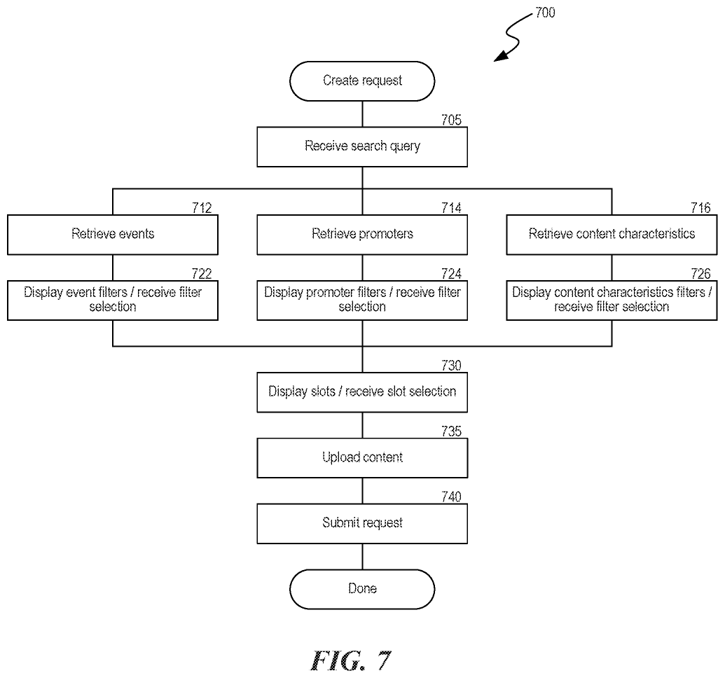

Returning to FIG. 2, after reviewing available slots in block 220, the system allows an artist to submit a request to fill an available slot at function block 225. The submission process 700 is illustrated in FIG. 7. As previously described with respect to the example of FIG. 6, an artist can use a system interface to search or filter for available slots. At block 705, the system receives a search query from an artist, for example via a search field 612. If the artist already has an event and/or specific slot in mind from previous reviews, they can enter that information to quickly bring up the slots. Alternatively, the system allows the artist to search or filter by event, promoter, or content characteristics. Depending on the search query that is received at block 705, the system may retrieve events that are responsive to the search query at block 712, promoters that are responsive to the search query at block 714, or available slots that are associated with specific content characteristics specified by the search query at block 716. In some embodiments, keywords received in a search query may be used to retrieve results in multiple categories and/or associated with other information assigned to slots/events. To narrow search results, the system can provide an interface to allow the artist to apply certain event filters 722, promoter filters 724, content characteristic filters 726, and/or other filters to allow artists to narrow displayed results. At block 730 the system displays the slots matching the elected filter(s) and allows the artist to select a specific slot for which the artist would like to submit content. When the artist has selected a desired slot, at block 735 the artist either identifies, to the system, the content that is being recommended by the artist for the desired slot (e.g., if the content was previously uploaded) or uploads the content to the system. At block 740, the system conveys the artist's submission to the corresponding promoter.

In some embodiments, the system can analyze tracks or other content uploaded by artists to create a report of the content characteristics, which can be provided to promoters when reviewing the submitted track or used by the system to filter tracks before presented to promoters. For example, U.S. Pat. No. 6,518,492, which is incorporated herein by reference in its entirety, is directed to a system that analyzes recorded music in order to estimate the beats per minute (BPM) of the recorded music. In some embodiments, the system can use the content analysis to prevent an artist from submitting content that does not have the content characteristics specified by the promoter. For example, if a musical artist submits a track that is analyzed to be approximately 100 BPM, and the DJ has specified that tracks submitted for a setlist slot have a BPM range of 120-130 BPM, the system may automatically prevent the submission from being presented to the DJ for review. In some embodiments, the system may still submit the track to the DJ, but flag the track to the DJ as falling outside of the desired BPM range.

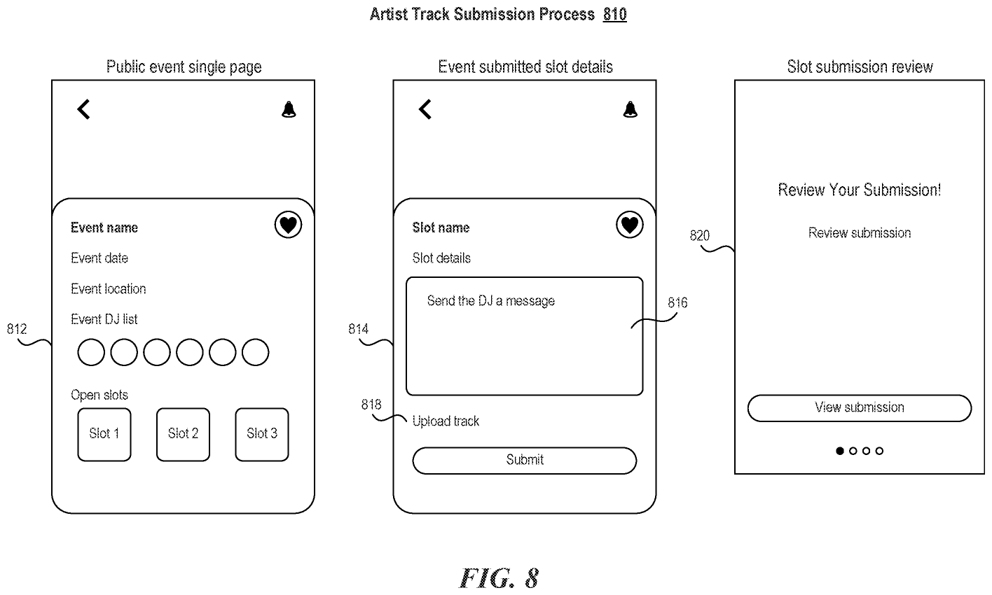

FIG. 8 is a display diagram of an example user interface 810, used when the artist is a musical artist and the promoter is DJ, that allows the artist to submit a track to a promoter for consideration. When an artist has narrowed a search to a particular event and/or setlist, the system displays a setlist detail page 812 to the artist. The setlist detail page includes certain information characterizing the event, as well as a list of the available slots that are available for submissions (in the depicted interface, “Slot 1,” “Slot 2,” and “Slot 3”). When an artist selects a desired slot, the system displays a slot submission page 814 to the artist. The slot submission page 814 includes a text entry field 816 in which the artist can enter a message to the DJ that will accompany the submitted track. The artist then selects an upload track button 818 to either upload or identify the track that the artist would like the DJ to consider. In some embodiments, the system also allows the artist to provide descriptive characteristics of the track, such as beats per minute (BPM), genre, pitch, pulse, tempo, rhythm, melody, harmony, texture, style, featured instruments, inclusion or exclusion of vocals, keys, timbre or color, dynamics, expression, articulation, form and structure, and/or other musical characteristics of the track that the artist would like to highlight to the DJ. Once the track has been identified, the artist selects the “Submit” button to submit the track to the system for conveyance to the DJ.

It will be appreciated that the displayed pages 812, 814 can contain a back button that returns the artist to the previous page to continue to review events, sets, and available slots if they do not want to submit a request for a selected slot. Artist submissions can be stored in the artist dataset 114. If the artist is interested in the status of submissions that they have made, the system provides a page 820 where the artist can navigate to see whether submissions made by the artist have been accepted, rejected, or are still pending. Among other things, this feature can allow an artist to submit a track to multiple slots, increasing its chance of being played, and cancel pending slots if the artist receives a desired number of acceptances for other slots.

Returning to FIG. 2, after an artist (or several artists) submits content to a promoter for an available slot, the promoter is able to review the submissions. At function block 230, the system retrieves existing submissions to allow the promoter to review and accept a submission for each available slot.

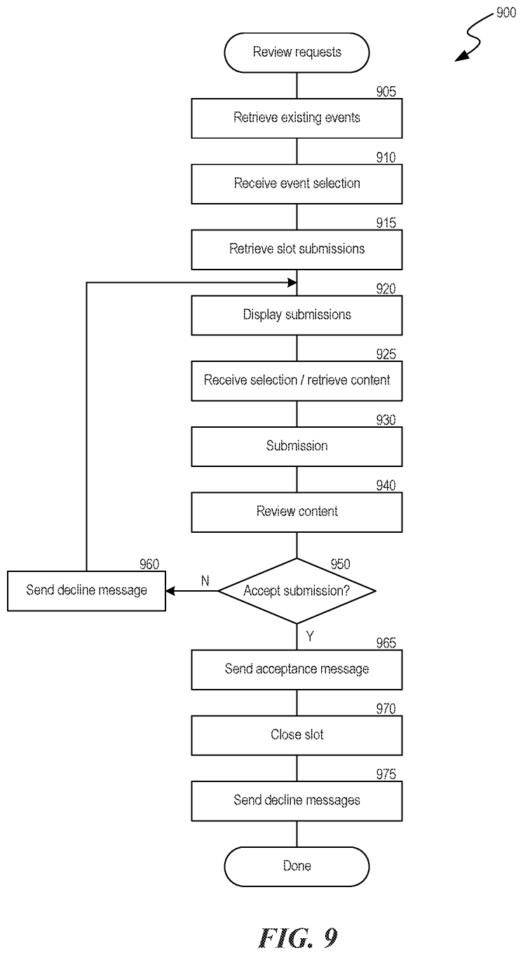

FIG. 9 is a flow diagram of a process 900 that, when executed by the system, allows the promoter to review and select content. At block 905 the system retrieves the existing events the promoter has created. At block 910, the system displays the retrieved events and receives a selection from the promoter on which event to review.

At block 915 the system retrieves slot submissions that are associated with the selected event. Those submissions may be received from one artist or multiple artists. At block 920 the system displays the submissions to the promoter. Those submissions may be presented to the promoter in, for example, a list. The list can show summary details about the submission such as, for example, the artist name and/or track name, a snippet of the message accompanying the submission, and/or various information related to the content (e.g., playtime, identified or provided content characteristics, etc.).

At block 925, the system receives the promoter's selection of a submission to review and retrieves information associated with the submitted content. At block 930, the system displays the submission information to the promoter. If the promoter is interested in viewing or listening to the submitted content, the system allows the promoter to review the content at block 940 (e.g., by playing or viewing the submitted content).

After reviewing the submission information and potentially reviewing the content, the system allows the promoter to either accept the submission or decline the submission at decision block 950. If the promoter does not accept the submitted content, at a block 960 the system sends a decline message to the artist and the submitted content is removed from the queue of pending submissions for the promoter to consider. In some embodiments, the system can allow the promoter to insert a personalized message to the artist regarding the denial. For example, the promoter may like the content but think it does not fit within the current event and may suggest the artist submit the content to another. Processing then continues to block 920, at which the promoter can consider another submission for the open slot. In this manner, the promoter can cycle through blocks 920-940 to review and evaluate the received submissions and select content that they are willing to play at the event. It will be appreciated that the system can also include an option to return to block 920 before the promoter decides to accept or decline a submission, allowing the promoter to review a number of (or all) submissions before accepting or declining any given submission.

If, however, the promoter accepts the submitted content to play in the available slot, processing continues to block 965. At block 965, the system sends an acceptance message to the artist. Once an acceptance message has been sent, the system closes the slot at block 970, meaning that the slot is no longer shown as open by the system and artists searching for open slots would not have the slot returned in search results. At block 975, the system, sends messages to artists associated with any remaining submissions for that slot, the messages indicating that other content was selected and the slot is now closed.

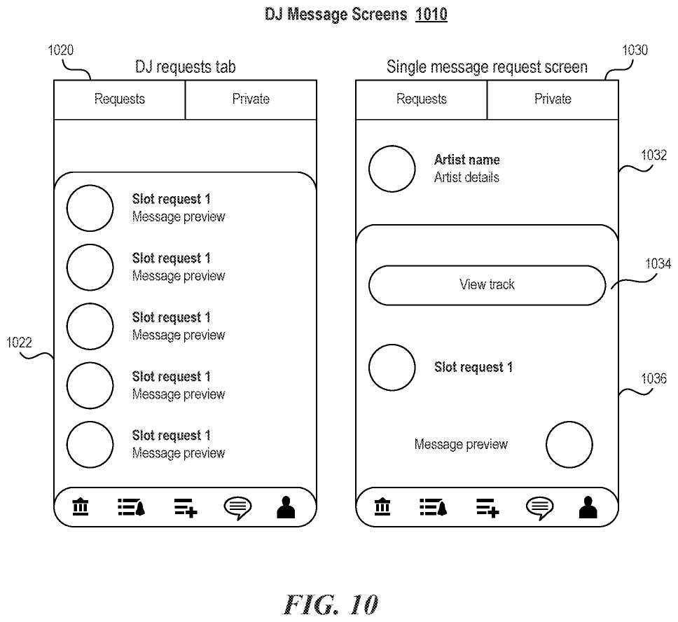

FIG. 10 is a display diagram of an example of a user interface 1010, in which the promoter is a DJ, that the system generates for the promoter to review submissions from artists. Those submissions may be presented to the DJ in, for example, a list 1022 of each submission. The list 1022 can show summary details about the submission such as, for example, the artist name and/or track name, a snippet of the message accompanying the submission, and/or various information related to the track (e.g., playtime, identified musical characteristics). Each of the displayed submissions can function as a button. When the DJ selects one of the slot submissions in list 1022, the system displays an interface 1030 of the selected submission. Interface 1030 includes details about the submitted track, including the artist name 1032 and details of the slot 1036 in which the artist would like the track played. To listen to the submitted track, the DJ may press button 1034. To continue reviewing submissions, the system can provide the DJ with a back button (not shown), which returns the DJ to interface 1020. In this fashion, the DJ can quickly toggle between the two screens and review all submitted tracks.

Returning to FIG. 2, at block 232 the system delivers the message regarding the promoter's decision to the artist. If the promoter accepted the artist's submission, the system then can require the artist to deposit funds corresponding to the slot price at block 234. By requiring payment before a promoter presents content in an event, the system helps ensure that the promoter is paid for a performance. That is, by putting the submitted amount into escrow, the system ensures that the artist cannot get their content presented, then refuse to make payment. In some embodiments, rather than put the charged amount into escrow, the system can deliver payment to the promoter immediately. Instead, a mechanism can be built into the system to provide a refund to the artist if the content is not presented as agreed by the promoter.

In some embodiments, protection for artists is accomplished via a requirement that an artist receive evidence that their content was performed as agreed (a “proof of play”) before the promoter receives payment. The proof of play may be generated by the promoter, by the artist, or by the system.

In some embodiments, the proof of play is generated by the promoter. Promoter-generated proof of play is particularly useful for live in-person events, since an artist might not be present at the event and proof that the artist's content was performed at the event would therefore be difficult to confirm. For example, at block 235, the system can send a reminder to the promoter to play the accepted content at (or just before) the designated time for a slot. When the content is being played in the performance, the system can further provide a recording feature in the application and require that the promoter record the performance. The recording feature can make use of a video camera and/or audio recorder of the mobile device used by the promoter to capture a short video of the performance and the crowd's reaction to the played track. The system can then add a verified date and time stamp on the captured video. In some embodiments, the system can also allow the promoter to review the recording at block 235 to ensure they are happy with the recording before it is submitted.

At block 240, the system stores the recording and sends a notice to the artist indicating that the proof of play recording has been submitted. At block 250, the system allows the artist to review the proof of play. At decision block 255, the artist is queried by the system as to whether the proof of play is accepted or denied. If the content was played as requested and approved by the artist, the system transmits payment to the promoter at block 260. If, however, the artist is not satisfied with the reviewed proof of play and denies the proof of play at block 255, the system refunds the artist at block 265. In some embodiments, when an artist denies the proof submitted, the proof can be provided to an administrator for review through the administrator application.

In some embodiments, the proof of play is directly confirmed by the artist. Artist-confirmed proof of play is particularly useful for network-accessible events, such as live streamed events or online posts. For example, if the content is being presented via a streaming channel that is readily accessible to the artist, the artist can directly confirm that the submitted content was actually presented as promised. In those embodiments, promoters may be required to provide the system with a URL, address, or other link to the social media, streaming, blog, or other channel via which the content will be presented. As the date and time of performance approaches, the system transmits a message to the artist that contains a URL along with a reminder of the date and time at which the content will be presented. After the date has passed, the system transmits a second message to the artist asking the artist to confirm that they observed the content being presented in the agreed-to fashion. If the artist views the content being presented in the agreed-to fashion, the artist may respond to the system with a message confirming that the content was appropriately presented. If, however, the artist does not see the content being presented, the artist may reply to the system with a message that the promoter had failed to perform as promised.

In some embodiments, the proof of play is captured by the system. System-confirmed proof of play is particularly useful for network-accessible events, such as live streamed events or online posts, that are accessible to the system. For example, at the date and time of the agreed-to performance, the system may access a URL, address, or other link to social media, streaming, blog, or other channel via which the content will be presented by the promoter. The system can capture, via video, all or a portion of the performance of the artist's content. The captured video is time-stamped to reflect the time of capture, and the URL or other address from which the video was captured is also stored in conjunction with the video. The system then transmits a message to the artist that contains a link to allow the artist to view the captured video and associated capture information. After reviewing the captured video, the system asks the artist to confirm that they observed the content being presented in the agreed-to fashion. If the artist agrees that the content was presented in the agreed-to fashion, the artist responds to the system confirming that the content was appropriately presented. If, however, the artist does not see the content being presented in the agreed-to fashion, the artist responds to the system that the promoter had failed to perform as promised. When an artist denies the proof submitted, the proof can be provided to an administrator for review and arbitration through the administrator application.

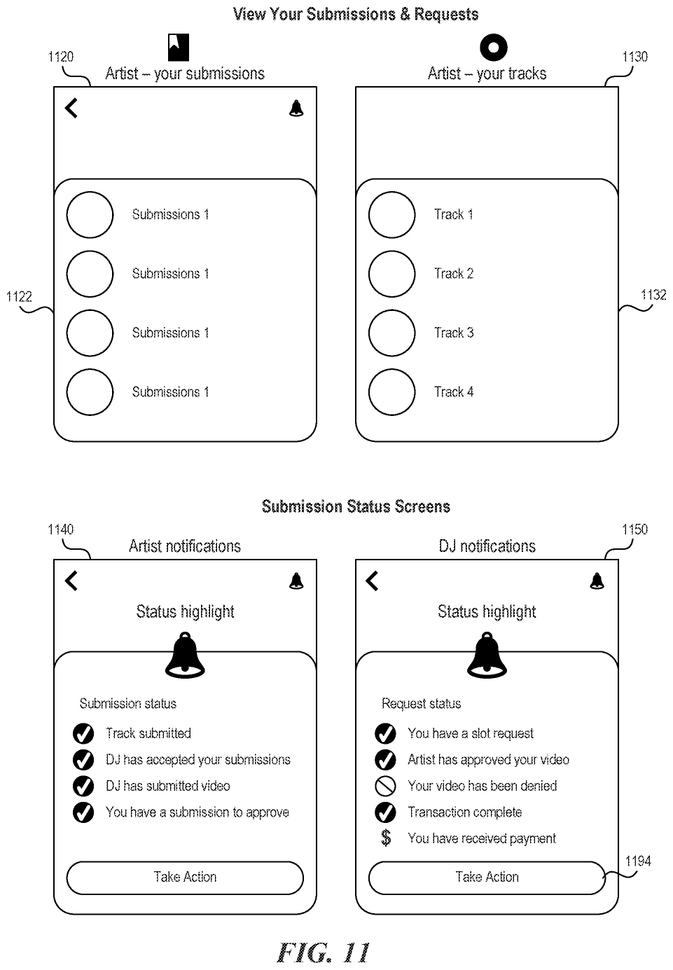

FIG. 11 is an illustration of additional example user interfaces that the promoters and artists use to interact with the system, in which the promoters are DJs. Interface 1120 is an example of a status screen that displays a list of submissions 1122 made by the artist to one or more DJs. The interface 1120 allows the artist to review the status of each submission, and check to see if it has been accepted, denied, or is still pending. Interface 1130 is an example of a status screen showing tracks that have been uploaded by the artist to the system and stored in in the artist dataset 114. Interface 1140 is an example notification screen generated by the system to provide the artist status on a submission. As illustrated, interface 1140 includes notifications regarding the submission, and an action button 1144 that can link an artist to one or more interfaces to allow the artist to cancel an existing submission, review an existing request to submit payment, review an existing request to review a proof of play, and/or take various other actions. Similarly, interface 1150 is an example status screen a DJ may be shown. Interface 1150 includes action button 1154 that can link a DJ to an interface to review submissions, approve/deny submissions, submit proof of play, deposit payments, and/or various other actions.

From the foregoing, it will be appreciated that specific embodiments of the invention have been described herein for purposes of illustration, but that various modifications may be made without deviating from the scope of the invention. Accordingly, the invention is not limited except as by the appended claims.

I/We claim:

1. A method performed by a computing system for connecting content promoters and artists for content promotion transactions, the method comprising:
receiving, at a computing system, performance information comprising:
parameters characterizing an event in which a content promoter will be participating, the parameters including a date and a time of the event; and
information about at least one available slot at the event during which the content promoter is willing to present digital media content, the information about each available slot at the event including characteristics of desired digital media content specified by the content promoter for the available slot and a price at which the content promoter is willing to present digital media content during the available slot;
publishing, by the computing system, the performance information, wherein the published performance information is accessible to multiple artists;
receiving, by the computing system, in response to the published performance information, an artist submission for an available slot at the event, the artist submission including digital media content associated with the artist;
providing, to the content promoter, the received digital media content associated with the artist;
receiving, from the content promoter, an indication that the received digital media content is accepted for the available slot; and
charging the artist the price associated with the available slot and remitting the charged price to the content promoter after the received digital media content has been presented by the content promoter.

2. The method of claim 1, wherein the received digital media content is a music track.

3. The method of claim 2, wherein the characteristics of desired digital media content include one or more of genre, vibe, tempo, or BPM.

4. The method of claim 2, wherein the event is a setlist and the content promoter is a DJ.

5. The method of claim 1, wherein the information about each available slot at the event further includes a slot time or slot length.

6. The method of claim 1, wherein the artist submission further includes a message to the promoter or characteristics of the submitted digital media content.

7. The method of claim 1, wherein the event is a social media post, live stream, or other online performance and the promoter is an influencer.

8. The method of claim 7, wherein the parameters characterizing the event further include an expected number of impressions.

9. The method of claim 1, further comprising generating an interface to allow the content promoter to review received digital media content for the available slot prior to accepting digital media content for the available slot.

10. The method of claim 1, wherein the available slot at the event is associated with a date and time for the available slot, the method further comprising:
providing, to the content promoter at or before the date and time for the available slot, a reminder notification to present the received digital media content during the available slot.

11. The method of claim 1, further comprising:
analyzing, by the computing system, the received digital media content for at least one of the characteristics of desired digital media content specified by the promoter.

12. The method of claim 1, wherein the price at which the content promoter is willing to present digital media content during the available slot is an ask price, and wherein the artist submission includes a bid price for the available slot that is less than the ask price, the method further comprising:
receiving, from the content promoter, an indication that the bid price for the available slot is accepted.

13. A non-transitory computer-readable medium carrying instructions that, when executed by a computing system, cause the computing system to perform operations comprising:
receiving, at a computing system, performance information comprising:
parameters characterizing an event in which a content promoter will be participating, the parameters including a date and a time of the event; and
information about at least one available slot at the event during which the content promoter is willing to present digital media content, the information about each available slot at the event including characteristics of desired digital media content specified by the content promoter for the available slot and a price at which the content promoter is willing to present digital media content during the available slot;
publishing, by the computing system, the performance information, wherein the published performance information is accessible to multiple artists;
receiving, by the computing system, in response to the published performance information, an artist submission for an available slot at the event, the artist submission including digital media content associated with the artist;
providing, to the content promoter, the received digital media content associated with the artist;
receiving, from the content promoter, an indication that the received digital media content is accepted for the available slot; and
charging the artist the price associated with the available slot and remitting the charged price to the content promoter after the received digital media content has been presented by the content promoter.

14. The non-transitory computer-readable medium of claim 13, wherein the event is a setlist, the content promoter is a DJ, and the received digital media content is a music track.

15. The non-transitory computer-readable medium of claim 14, wherein the characteristics of desired digital content include one or more of genre, vibe, tempo, or BPM.

16. The non-transitory computer-readable medium of claim 13, wherein the information about each available slot at the event further includes a slot time or slot length.

17. The non-transitory computer-readable medium of claim 13, wherein the artist submission further includes a message to the promoter or characteristics of the submitted digital media content.

18. The non-transitory computer-readable medium of claim 13, wherein the event is a social media post, live stream, or other online performance and the promoter is an influencer.

19. The non-transitory computer-readable medium of claim 18, wherein the parameters characterizing the event further include an expected number of impressions.

20. The non-transitory computer-readable medium of claim 13, the operations further comprising:
analyzing, by the computing system, the received digital media content for at least one of the characteristics of desired digital media content specified by the promoter.
